(19) United States
(12) Patent Application Publication
(10) Pub. No.: US 2019/0280349 A1
(43) Pub. Date: Sep. 12, 2019

(54) GRIDLESS MOBILE HABITAT

(71) Applicant: Albert Benton Salmon, JR., Marshall, TX (US)

(72) Inventor: Albert Benton Salmon, JR., Marshall, TX (US)

(21) Appl. No.: 16/294,461

(22) Filed: Mar. 6, 2019

Related U.S. Application Data
(60) Provisional application No. 62/641,030, filed on Mar. 9, 2018.

(51) Int. Cl. H01M 10/46; H02J 7/00; H01M 10/04

(52) U.S. Cl. CPC H01M 10/465; H01M 10/04; H02J 7/0027; H02J 7/0042

(57) ABSTRACT

The present disclosure provides for a gridless mobile habitat, including a power system. The power system includes a battery pack, an inverter, and solar extending within a single plane that is at an angle relative to the ground. The inverter is electrically coupled with electrically powered devices. The gridless mobile habitat includes a water system to provide potable water, including a water tank, a pump, and a water heater. The gridless mobile habitat includes an electrically powered incinerating toilet. Also disclosed is a method of providing a habitat in a gridless environment at geographic locations that lack a functioning power grid.

### CROSS-REFERENCE TO RELATED APPLICATIONS

The present application claims the benefit of United States Provisional Patent Application No. 62/641,030 (pending), filed on Mar. 9, 2018, the entirety of which is incorporated herein by reference and made a part of the present disclosure.

### FIELD

The present disclosure relates to gridless mobile habitats for use in locations where access to power grids, potable water sources, natural gas lines, sewage systems and/or other municipal and utility services are not available, including processes, systems, and apparatus for making and using the same.

### BACKGROUND

Providing municipal and utility services, such as electrical power, potable water sources, natural gas, and/or sewage treatment can be challenging in certain locations and/or circumstances. For example, some locations are remote from locations that provide such municipal and utility services, such as at remote oil and gas wells or other remote locations. Furthermore, even locations that typically have access to such municipal and utility services can lose such access during and/or after the occurrence of a natural or man-made disaster, such as a hurricane. For example, hurricanes can disrupt one or more municipal and utility services for days or even months. Nonetheless, the need for utilities, including electrical power, at such locations and under such circumstances remains.

### BRIEF SUMMARY

One embodiment of the present disclosure includes a gridless mobile habitat. The gridless mobile habitat includes an exterior, including a roof, a floor, and one or more walls. The roof extends within a single plane that is at an angle relative to a plane that the floor extends within. An interior spaced is defined by the exterior. One or more electrically powerable devices are positioned on the exterior, positioned in the interior space, or combinations thereof. The gridless mobile habitat includes a power system, including a battery pack, an inverter, and one or more solar panels positioned on the roof. The one or more solar panels extend within a single plane that is at an angle relative to the plane that the floor extends within. The inverter is electrically coupled with the battery pack, the one or more solar panels, and the one or more electrically powered devices, and is positioned to distribute electrical power from the battery pack, the one or more solar panels, or combinations thereof to the one or more electrically powered devices. The roof and the one or more solar panels are positioned at angle relative to the floor that is greater than 0 degrees and less than 90 degrees.

Another embodiment of the present disclosure includes a gridless mobile habitat. The gridless mobile habitat includes an exterior, including a roof, a floor, and one or more walls. The roof extends within a single plane that is at an angle of from 5 to 60 degrees relative to a plane that the floor extends within. An interior spaced is defined by the exterior. One or more electrically powerable devices are positioned on the exterior, positioned in the interior space, or combinations thereof. The gridless mobile habitat includes a power system, including a battery pack, an inverter, and one or more solar panels positioned on the roof. The one or more solar panels are coupled with the roof via a mounting device that is adjustable to provide the one or more solar panels with an adjustable angle, relative to the floor. The one or more solar panels extend within a single plane that is at an angle of from 5 to 60 degrees relative to the plane that the floor extends within. The inverter is electrically coupled with the battery pack, the one or more solar panels, and the one or more electrically powered devices, and is positioned to distribute electrical power from the battery pack, the one or more solar panels, or combinations thereof to the one or more electrically powered devices. The gridless mobile habitat includes a water system configured to provide potable water to the gridless mobile habitat. The water system includes a water tank containing potable water, a pump fluidly coupled with the water tank and electrically coupled with the power system, and a water heater for heating the potable water. The water heater is electrically coupled with the power system. The pump is fluidly coupled with a sink, shower, refrigerator, dishwasher, water heater, washing machine, water hose, dishwasher, or combinations thereof of the gridless mobile habitat. The gridless mobile habitat includes an electrically powered incinerating toilet positioned within the interior space. The electrically powered incinerating toilet is electrically coupled with the power system.

Another embodiment of the present disclosure includes a method of providing a habitat in a gridless environment. The method includes providing a gridless mobile habitat in a geographic location that lacks a functioning power grid. The gridless mobile habitat includes an exterior comprising a roof, a floor, and one or more walls. The roof extends within a single plane that is at an angle relative to a plane that the floor extends within. An interior spaced is defined by the exterior. One or more electrically powerable devices are positioned on the exterior, positioned in the interior space, or combinations thereof. The gridless mobile habitat includes a power system, including a battery pack, an inverter, and one or more solar panels positioned on the roof. The one or more solar panels extend within a single plane that is at an angle relative to the plane that the floor extends within. The inverter is electrically coupled with the battery pack, the one or more solar panels, and the one or more electrically powered devices, and is positioned to distribute electrical power from the battery pack, the one or more solar panels, or combinations thereof to the one or more electrically powered devices. The method includes selectively providing power to the one or more electrically powerable devices from the one or more solar panels and the battery pack. The method includes disposing of sewage using an electrically powered incinerating toilet. The method includes providing potable water from a water system, the water system electrically coupled with the power system.

### BRIEF DESCRIPTION OF THE DRAWINGS

So that the manner in which the features and advantages of the systems, products, apparatus, and/or methods of the present disclosure may be understood in more detail, a more particular description briefly summarized above may be had by reference to the embodiments thereof which are illustrated in the appended drawings that form a part of this specification. It is to be noted, however, that the drawings illustrate only various exemplary embodiments and are therefore not to be considered limiting of the disclosed concepts as it may include other effective embodiments as well.

FIG. 1 depicts a side view of a skid mounted, gridless mobile habitat having a power system incorporated therewith.

FIG. 2 is an end view of a skid mounted, gridless mobile habitat.

FIG. 3A is a view of solar panels at a first angle.

FIG. 3B is a view of solar panels pivoted from the first angle to a second angle.

FIG. 4 is a detail view of a portion of a power system.

FIG. 5 is a detail view of a controller for an inverter.

FIG. 6 is a detail view of a charge controller.

FIG. 7 is an end, cross-sectional view of a skid mounted, gridless mobile habitat, showing the interior thereof.

FIG. 8 is a top, cross-sectional view of a skid mounted, gridless mobile habitat, showing the interior thereof.

FIG. 9 is a simplified schematic of the power generation system.

FIG. 10A is a view of the gridless mobile habitat with the solar panels at a first angle.

FIG. 10B is a view of the gridless mobile habitat with the solar panels at a second angle, greater than the first angle of FIG. 10A.

FIG. 11A is a view of the gridless mobile habitat with the solar panels at a first angle.

FIG. 11B is a view of the gridless mobile habitat with the solar panels at a second angle, greater than the first angle of FIG. 11A, with the angle of each solar panel or section of solar panels independently controllable.

Products, apparatus, systems, and methods according to present disclosure will now be described more fully with reference to the accompanying drawings, which illustrate various exemplary embodiments. Concepts according to the present disclosure may, however, be embodied in many different forms and should not be construed as being limited by the illustrated embodiments set forth herein. Rather, these embodiments are provided so that this disclosure will be thorough as well as complete and will fully convey the scope of the various concepts to those skilled in the art and the best and preferred modes of practice.

### DETAILED DESCRIPTION

Certain aspects of the present disclosure include processes, systems, and apparatus for providing municipal and utility services (e.g., electrical power) to manufactured housing and other contained environments. The processes, systems, and apparatus disclosed herein may be used to provide municipal and utility services in remote locations and/or disaster zones, such as in locations that are remote from power grids and/or locations where the local power grid is not functioning to provide power. U.S. Pat. No. 8,981,709 (the '709 patent) provides certain background information relevant to the present disclosure. Accordingly, the disclosure of the '709 patent is hereby incorporated by reference and made a part of the present disclosure, but only to the extent that incorporated subject matter provides background information and/or exemplary or explanatory disclosure regarding systems, apparatus (and arrangements thereof) suitable for use with the processes, systems, and apparatus disclosed herein. Thus, the incorporated subject matter of the '709 patent shall not serve to limit the scope of the present disclosure.

The present disclosure includes gridless mobile habitats for use in locations where access to power grids, potable water sources, natural gas lines, sewage systems and/or other municipal and utility services are not available, including processes, systems, and apparatus for making and using the same. As used herein, “gridless” refers to the fact that the relevant mobile habitat is not connected to a utility grid (e.g., an electrical power grid), or is at least not connected to a functioning utility grid. In some embodiments, the mobile habitat is, therefore, gridless or off-the-grid, such that the mobile habitat is lacking connection to a grid and/or is located remotely from a grid. The mobile habitat may be at least partially self-sufficient, such that the mobile habitat is capable of providing utility services to the inhabitants thereof without requiring connection to a functioning utility grid. In some such aspects, the mobile habitat is capable of providing electrical power services to the inhabitants thereof without requiring connection to a functioning electrical power grid; is capable of providing potable water services to the inhabitants thereof without requiring connection to a functioning external potable water source; is capable of providing sewage disposal services to the inhabitants thereof without requiring connection to a functioning sewage treatment service; or combinations thereof.

### Mobile Power

Certain aspects of the present disclosure include apparatus, systems, and processes directed to providing power to temporary living structures in remote locations and/or disaster zones. A power generation system, including one or more solar panels and one or more batteries may be integrated with the living structure, and the living structure may be easily transportable to the location, such as in the instance of an emergency (e.g., hurricane relief). The solar panel may provide the living structure with power during times in which the solar panel is receiving sunlight (i.e., during the day), and the solar panel may simultaneously provide power to the batteries to charge the batteries. The batteries may provide the living structure with power during times in which the solar panel is not receiving sunlight (i.e., during the night). The system may be configured such that provision of power from the batteries or the solar panel is switched therebetween depending upon the circumstances. For example, if the sun is providing sufficient sunlight to the solar panel for the solar panel to provide sufficient power to the living structure, then the solar panel provides the power to the living structure and the batteries are charged by additional power from the solar panel. If the sun is not providing sufficient sunlight to the solar panel for the solar panel to provide sufficient power to the living structure, then the batteries provide the power to the living structure. In some aspects, if the sun is providing some sunlight but not providing sufficient sunlight to the solar panel for the solar panel to fully power the living structure, then the batteries and solar panel simultaneously provide power to the living structure.

Some embodiments include a transportable manufactured housing structure having a power generation system integrated therewith. The transportable manufactured housing structure includes a floor structure, multiple walls coupled with the floor structure, and a roof coupled with the multiple walls. The floor structure, walls and roof define an interior of the transportable manufactured housing structure. The interior forms an enclosed living space. A solar panel is positioned on an exterior of the transportable manufactured housing structure. A battery pack is electrically coupled with the solar panel. The solar panel and the battery pack are arranged such that the solar panel charges the battery pack. An inverter is electrically coupled with the solar panel and the battery pack. The invertor is configured to convert DC power to AC power. An AC power port is electrically coupled with the inverter. The AC power port is positioned to provide AC power to one or more electrically powered devices on the exterior of the transportable manufactured housing structure, within the interior of the transportable manufactured housing structure, or combinations thereof. The inverter is configured to selectively and alternatively provide power to the AC power port from the solar panel, the battery pack, or both.

Some embodiments include a process for providing electrically powered living environments in remote locations or disaster zones. The process includes providing a transportable manufactured housing structure in accordance with any of the embodiments disclosed herein. In some embodiments, the process includes integrating a power generation system with a transportable manufactured housing structure.

In certain embodiments, a system including one or more solar panels, converters, charger controllers, inverters, and battery packs are provided, and are integrated with a manufactured home, shipping container, storage facility, mobile home, park model, or any structure having wheels or skids that may be used as an at least temporary living space. In some such embodiments, the roof of such a structure is modified and/or built to have a pitch configured to account for the angle of the Sun at the geographic location where the structure is to be used. For example, the roof of a mobile home having a solar panel integrated thereon may be at one angle when the mobile home is used to provide power at a first geographic location near the Equator, and at another, different angle when the mobile home is used to provide power at a second geographic location further from the Equator than the first geographic location. In some such embodiments, the solar panel is mounted on the roof using a mounting device that provides the angle to the solar panel. In some aspects, the mounting device is adjustable, to provide the solar panel with an adjustable angle. The mounting device may be used to change the declination of the solar panel, to provide the solar panel with an optimal and/or maximum amount of impact with radiation from the Sun. For example, and without limitation, the mounting device may include pivotable brackets connecting between the roof and solar panel.

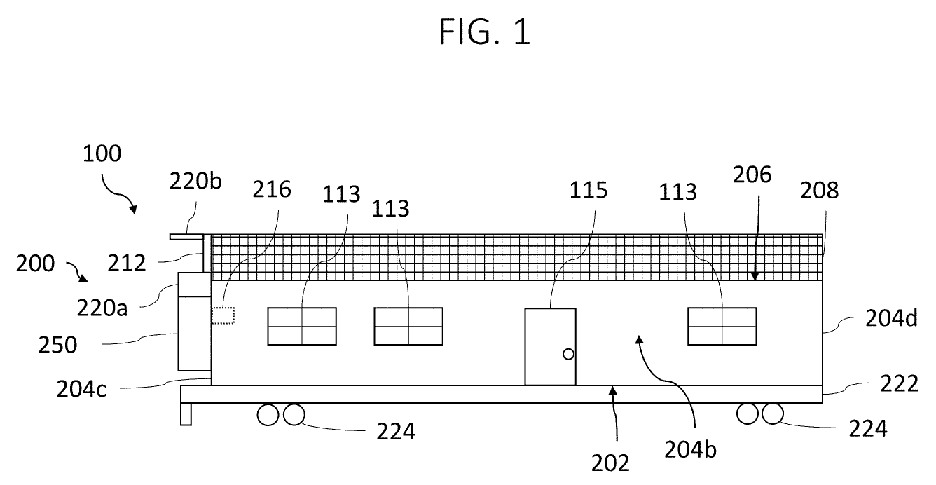

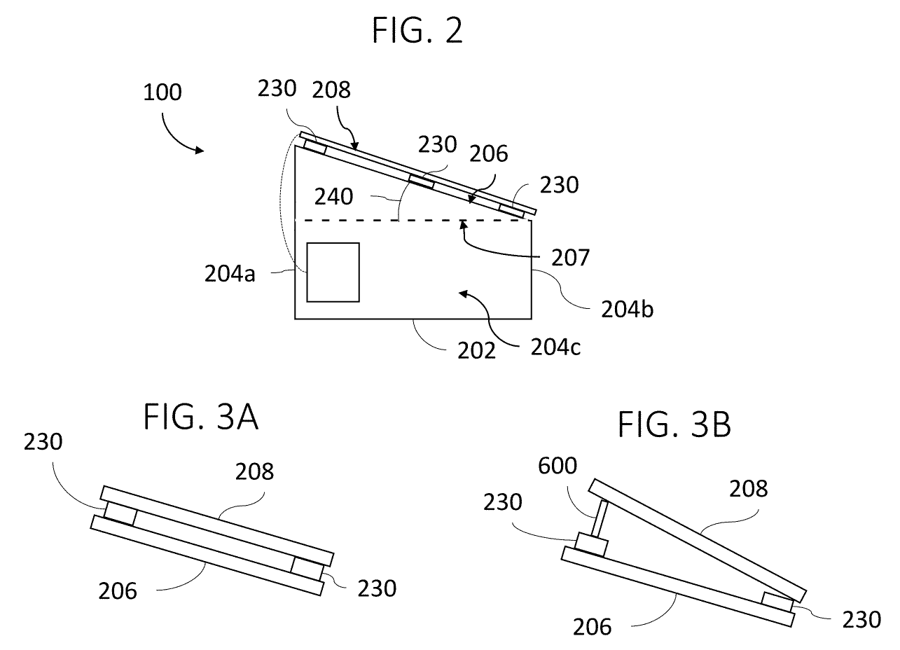

Turning now to the Figures, with reference to FIGS. 1 and 2, gridless mobile habitat 100 (e.g., a transportable manufactured housing structure) is shown and described. Gridless mobile habitat 100 may be skid mounted manufactured housing structure, including skid 222 with wheels 224. Gridless mobile habitat 100 includes walls 204a-204d coupled with floor structure 202 (also referred to as base) and with roof structure 206, defining interior living space 300 (as shown in FIGS. 6 and 7). Gridless mobile habitat 100 includes windows 113 and door 115.

Gridless mobile habitat 100 includes power system 200 integrated therewith. Power system 200 may be a system configured to generate and/or distribute electrical power to gridless mobile habitat 100 without requiring connection with an electrical power grid. Power system 200 includes one or more solar panels 208 positioned on an exterior of gridless mobile habitat 100. While solar panels 208 are shown positioned on roof 206, solar panels may be positioned on other portions of gridless mobile habitat 100. One or more mounting devices 230 mechanically couple solar panels 208 with gridless mobile habitat 100. Mounting devices 230 may be or include structural channeling (e.g., U-channels) coupled with and between roof 206 and solar panels 208.

### Angled Solar Panels and Roof

In certain aspects, roof 206 is positioned at angle 240 relative to floor 202. Line 207 in FIG. 2 shows where roof would be if roof were positioned at an angle of 0 degrees relative to floor 202. However, roof 206 is at an angle of greater than 0 and less than 90 degrees, relative to floor 202. In certain embodiments, roof 206 is at an angle of from 5 to 60 degrees relative to floor 202, or from 10 to 50 degrees relative to floor 202, or from 15 to 40 degrees relative to floor, or from 20 to 30 degrees relative to floor 202. The angle of roof 206 and/or solar panels 208, relative to floor 202, may correspond with a geographical location of gridless mobile habitat 100. For example, each geographic location may have an angle associated therewith, where solar panels 208 are capable of harvesting the greatest amount of energy from the Sun, also referred to herein as the “optimum angle”. The optimum angle may vary from one geographic location to another. For example, in a first geographic location at a first distance from the Equator, the optimum angle may be about 5 degrees (i.e., the roof and solar panels are at an angle of about 5 degrees relative to the floor and/or ground). At a second geographic location that is at a second distance that is closer to the Equator, the optimum angle may be greater than 5 degrees. As such, by varying the angle of the roof 206 and/or solar panels 208 relative to the floor 202 and/or ground, the amount of energy harvested by solar panels 208 can be optimized for the particular geographic location of gridless mobile habitat 100.

In certain embodiments, roof 206 and solar panels 208 are positioned at angle 240 by varying the heights of walls 204a and 204b of gridless mobile habitat 100. For example, wall 204a may have a greater height than wall 204b. In one exemplary embodiment, wall 204a has a height of about thirteen feet and wall 204b has a height of about ten to eleven feet. Roof 206 may be slanted roof that is at a single angle relative to floor 202 and/or ground, such that an entirety of the top surface of roof 206 sits in a single plane. In some embodiments, roof 206 is not a gabled roof. In some embodiments, roof 206 is not an A-frame roof

In certain embodiments, mounting device 230 is adjustable to change the inclination and declination of solar panels 208 relative to the Sun. For example, mounting device 230 may be or include lift mechanism 600, as shown in FIGS. 3A and 3B. Lift mechanism 600 may be actuable to take at least two positions, including a first position (not visible) as illustrated in FIG. 3A, and a second position as shown in FIG. 3B. Lift mechanism 600 may be a hydraulically actuable piston that extends in response to hydraulic pressure. Lift mechanism 600 may be a piston or other structure that is extendable and retractable in response to an electric motor, a crank, or another apparatus. In some embodiments, lift mechanism 600 is a pivoting bracket capable of pivoting between at least two positions.

While gridless mobile habitat 100 is shown as a mobile home mounted on skid 222, including wheels 224, the gridless mobile habitats disclosed herein are not limited to this particular structure, and may be a shipping container, a park model, a storage unit, or another transportable structure capable of providing an at least temporary living space.

### Power System

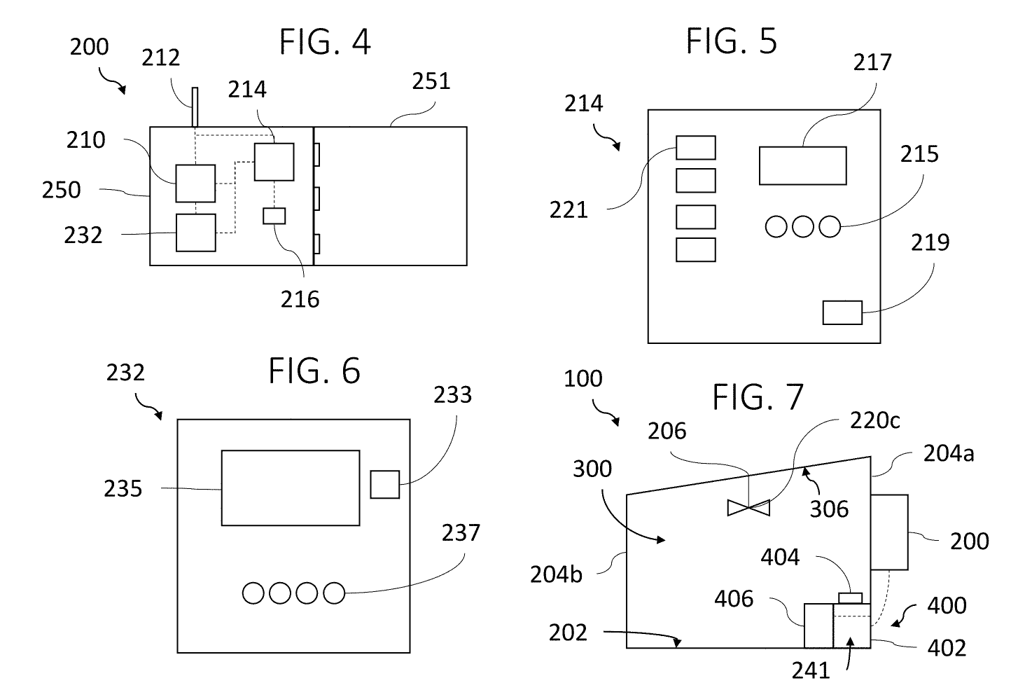

With reference to FIGS. 1 and 4, power system 200 is electrically coupled with solar panels 208, such as through conduit 212. Power system 200 may receive, store, and/or distribute electrical power harvested by solar panels 208. In some embodiments, power system 200 is electrically coupled with one or more exterior electrically powered devices 220a and 220b to provide electrical power thereto. For example, device 220a may be an air conditioning unit to provide air conditioning to the interior of gridless mobile habitat 100, and device 220b may be an exterior light to provide light to an environment external to gridless mobile habitat 100.

In some embodiments, power system 200 of gridless mobile habitat 100 includes housing 250. Housing 250 may be a structurally rigid, weather-resistant housing. In one exemplary embodiment, housing 250 is a stainless steel housing, including door 251. Door 251 may be opened and closed to provide selective access to portions of power system 200. Housing 250 may provide weather resistance and protection from theft for power system 200. Housing 250 may be mechanically coupled to an exterior of gridless mobile habitat 100, such as to one of walls 204a-204d, roof 206, floor 202, or combinations thereof.

Power system 200 includes battery pack 210 electrically coupled with inverter 214, both of which are contained within housing 250. Battery pack 210 is electrically coupled with solar panels 208, such as via wire extending from solar panels 208 through conduit 212. Solar panels 208 and battery pack 210 are arranged such that solar panels 208 selectively charge battery pack 210.

Inverter 214 is electrically coupled with solar panels 208 and battery pack 210. Invertor 214 is configured to convert DC power from solar panels 208 or battery pack 210 into AC power for use in powering devices inside and outside of gridless mobile habitat 100.

AC power port 216 is electrically coupled with inverter 214 for receiving power therefrom. AC power port 216 is positioned to provide AC power to one or more electrically powered devices 220a and 220b on the exterior of the gridless mobile habitat 100, one or more electrically powered devices within the interior of gridless mobile habitat 100, or combinations thereof. Inverter 214 is configured to selectively and alternatively provide power to AC power port 216 from solar panels 208 and the battery pack 210.

Charge controller 232 may be electrically coupled with the battery pack 210 and solar panel 208, and configured to selectively charge battery pack 210 with power from the solar panel 208.

FIG. 5 depicts one exemplary control panel of inverter 214 and FIG. 6 depicts one exemplary control panel of charge controller 232. Control panel of inverter 214 may include one or more indicators 221 (e.g., lights). Indicators 221 may indicate the source of power (e.g., solar panels 208 or battery 210), the occurrence of an event, and equalizing of batteries 210. Control panel of inverter 214 may include charge indicator 215 indicating the level of charge of batteries 210. Control panel of inverter 214 may include power button 219 and indicator 217, which may display current, wattage, whether or not power is being drawing from the batteries 210, and whether or not charging of the batteries 210 is occurring.

Control panel of charge controller 232 may display system status information on display 235, including a battery level and a load. Control panel of charge controller 232 may include control buttons, such as power/standby button 233, and menu control buttons 237 for navigating and controlling display 235. Control panel of charge controller 232 may also include an event/warning indicator (e.g., light, not shown). Thus, each control panel may provide the ability to adjust certain variable parameters of the respective devices and to monitor conditions of the respective devices and associated functions.

### Interior of Habitat

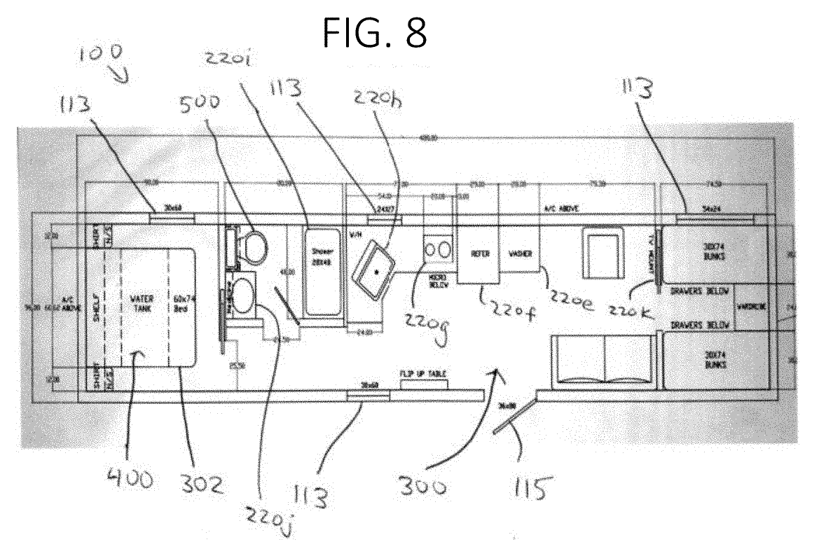

With reference to FIGS. 7 and 8, interior 300 of gridless mobile habitat 100 is depicted. As shown in FIG. 7, power system 200 may be electrically coupled with one or more interior electrically powered devices 220c. Electrically powered device 220c may be a light and/or ceiling fan, for example. The electrically powered devices may be an appliance, such as a dishwasher, washing machine, refrigerator, oven, stove, water heater, microwave, dryer, or another device. While not shown in FIG. 7, power system 200 may be electrically coupled with electrically powered device 220c through AC power port 216. Ceiling 306 may have an angle relative to floor 202 that corresponds with the angle of roof 206, and may provide additional storage space.

### Water System

Gridless mobile unit 100 includes water system 400. Water system 400 may be powered by power system 200, such as through AC power port 216. In some embodiments, water system 400 is or includes water tank 402 containing potable water 241. In some such embodiments, water system 400 includes pump 404 fluidly coupled with tank 402 for pumping potable water 241 to various components, devices, or fixtures that require water within in an interior and/or exterior of gridless mobile habitat 100. For example, pump 404 may pump potable water 241 to one or more sinks, showers, bathtubs, refrigerators, dishwashers, water heaters, water hoses, and washing machines of gridless mobile habitat 100. In some embodiments, water system 400 includes water heater 406 for heating potable water 241 prior to being pumped.

### Sewage System and Additional Interior Components

With reference to FIG. 8, interior 300 of gridless mobile habitat 100 may include water system 400 positioned beneath one of beds 302 (e.g., under a murphy bed). Interior 300 of gridless mobile habitat 100 may include one or more components, devices or fixtures in need of potable water, such as toilet 500, bathroom sink 220j, shower 220i, kitchen sink 220h, refrigerator 220f, and washer 220e (e.g., dish or clothes washer), each of which may be in fluid communication with water system 400 for having water (heated or not) pumped thereto.

Interior 300 of gridless mobile habitat 100 may include one or more components, devices or fixtures in need of electrical power, such as stove 220g, refrigerator 220f, washer 220e, and television 220k, each of which may be electrically coupled with power system 200 for having electricity provided thereto. In some embodiments, toilet 500 is an electrically powered toilet that incinerates waste. In some such embodiments, toilet 500 is electrically coupled with power system 200. For example, toilet 500 may be an INCINOLET™ electric incinerating toilet.

### System

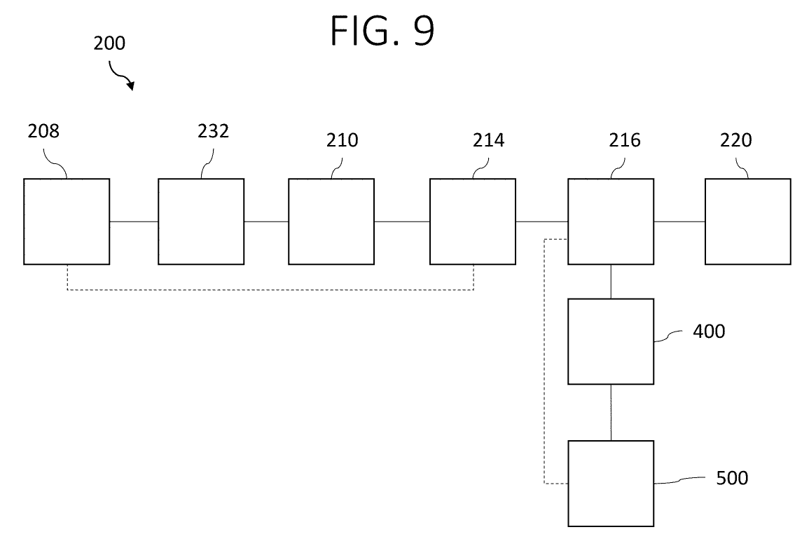

FIG. 9 is a simplified schematic of the arrangement of portions of the power system disclosed herein. Power system 200 is not limited to the particular arrangement shown. Solar panels 208 are electrically coupled with charge controller 232, charge controller 232 is electrically coupled with battery pack 210, battery pack 210 is electrically coupled with invertor 214, inverter 214 is electrically coupled with AC power port 216, and AC power port 216 is electrically coupled with device 220. In operation, solar panels 208 receives energy from sunlight and converts the energy into DC current, which is transmitted to charge controller 232. Charge controller 232 selectively transmits DC current to the battery pack 210 for charging thereof. In some aspects, DC current flows directly from solar panels 208 to inverter 214. In other aspects, the DC current passes through battery pack 210 and then to inverter 214. Inverter 214 receives DC current, converts the DC current to AC current, and transmits the AC current to the AC power port 216. AC power port 216 transmits AC power to one or more devices 220. Power system 200 may also power water system 400. Sewage system 500 may be powered by power system 200 and provided with potable water by water system 400.

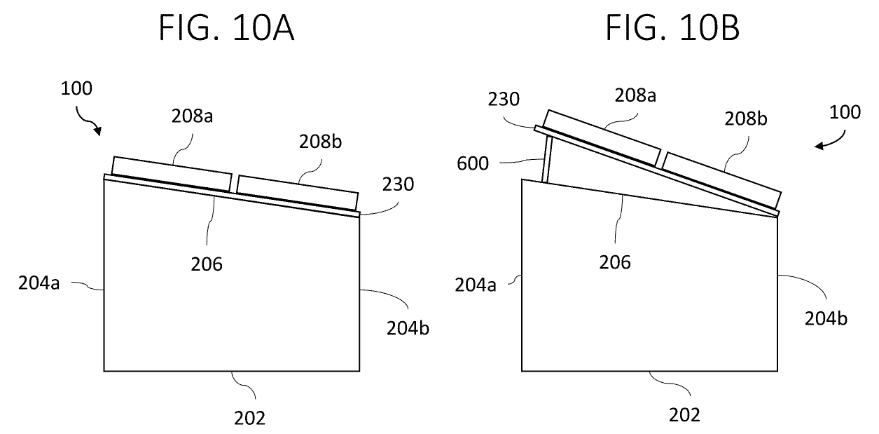

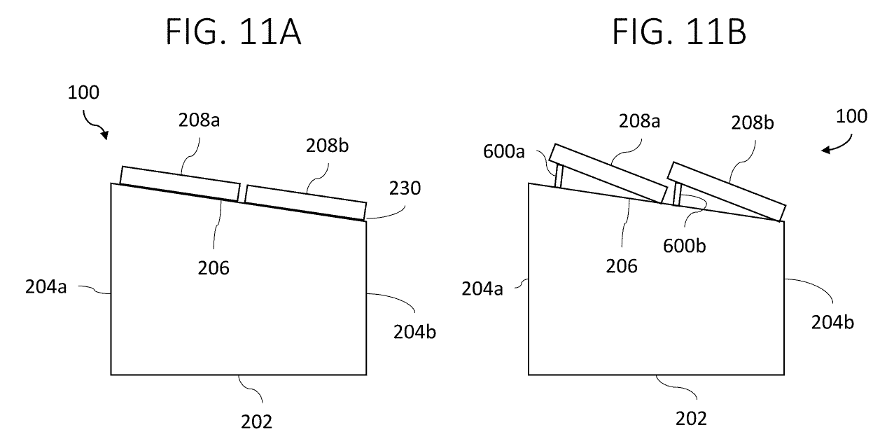

With reference to FIGS. 10A-11B, in some embodiments roof 206 is modified by extending the internal wall studs of wall 204a to heighten wall 204a and provide roof 206 with an angle relative to floor 202. In some embodiments, mounting bracket 230 allows solar panels 208a and 208b to move up or down, relative to roof 206, via a supporting arm 600. Supporting arm 600 may be a hydraulically or manually articulating supporting arm 600 or piston. In some embodiments, one or more supporting arms 600 lift all solar panels 208a and 208b on roof 206 simultaneously, or at least lift all solar panels 208a and 208b within a section on roof 206 simultaneously (as shown in FIGS. 10A and 10B). In some embodiments, each solar panel and, or each section of solar panels 208a and 208b is lifted separately from other solar panels or sections of solar panels (as shown in FIGS. 11A and 11B).

Thus, the solar panels may be selectively angled dependent upon the particular location. For example, if gridless mobile habitat 100 is at a first location (e.g., Puerto Rico), the solar panels may be positioned at a first angle of, for example, 10 degrees relative to floor 202. However, if gridless mobile habitat 100 is at a second location (e.g., Houston), the solar panels may be positioned at a second angle of, for example, 20 degrees relative to floor 202. As gridless mobile habitat 100 is positioned further North, the angle of the solar panels may be increased. In some embodiments, the solar panels are coupled on a fixed beam mounting device. With battery pack 210, gridless mobile habitat 100 may be provided with electrical power regardless of whether the Sun is shining.

### Method for Providing Utilities

Certain embodiments of the present disclosure include a method for providing utilities, including electrical power, to living environments in remote locations or disaster zones. The method includes providing a transportable manufactured housing structure. The location or disaster zone may be a remote geographic location lacking a power grid (e.g., an oil/gas drilling site). The location or disaster zone may be a geographic location having a power grid that is out of service. For example, the location or disaster zone may be a geographic having recently been impacted by an event that has caused the service of the power grid to be interrupted, such as a hurricane, an earthquake, a tornado, a tsunami, another storm, another natural disaster, or a man-made disaster. The method may include providing power using the power systems disclosed herein, including solar and battery power; providing sewage via an incinerating toilet; providing potable water via the water system disclosed herein; or combinations thereof.

In some embodiments, the method includes integrating the power system, water system, sewage system (incinerating toilet), or combinations thereof into a transportable manufactured housing structure.

In some embodiments, the method includes positioning the solar panels on the roof of the transportable manufactured housing structure, and adjusting an angle of the solar panels relative to the Sun. In some embodiments, the method includes positioning the roof of the transportable manufactured housing structure at an angle relative to the floor of the transportable manufactured housing structure. The angle of the roof and solar panels may be arranged to correspond with a geographical location of the transportable manufactured housing structure.

The method may include selectively controlling the charging of the battery using a charge controller. The method may include powering one or more electrically powered devices including an air conditioning unit, lights, appliances, a water heater, or combinations thereof providing potable water to one or more devices; providing for sewage disposal; or combinations thereof.

### Method of Modifying a Habitat

Some embodiments include a method of modifying a habitat to provide the habitat with electrical power, potable water, and/or sewage services. The method may include positioning the roof of the habitat at a single angle relative to the floor of the habitat. The single angle may be provided by increasing the height of one wall of the habitat relative to another, opposing wall of the habitat, or by decreasing the height of one wall of the habitat relative to another, opposing wall of the habitat. The single angle may be provided in view of the geographic location or expected geographic location of the habitat. The method may include mounting solar panels on the roof, optionally using adjustable mounting devices that allow the angle of the solar panels relative to the roof to be varied. The method may include coupling batteries with the solar panels, coupling an inverter with the solar panels and/or batteries, and coupling the inverter with one or more electrically powerable devices. The method may include providing the habitat with a water tank, water heater, and water pump, electrically coupling the water heater and water pump with the inverter, and fluidically coupling the water heater and water pump within one or more fixtures and/or appliances. The method may include providing the habitat with an incinerating toilet, electrically coupling the toilet with inverter, and fluidically coupling the toilet with the pump.

### Embodiments

Embodiment 1. A transportable manufactured housing structure having a power generation system integrated therewith, the transportable manufactured housing structure comprising: a floor structure, multiple walls coupled with the floor structure, and a roof coupled with the multiple walls, wherein the floor structure, walls and roof define an interior of the transportable manufactured housing structure, the interior forming an enclosed living space; a solar panel positioned on an exterior of the transportable manufactured housing structure; a battery pack electrically coupled with the solar panel, wherein the solar panel and the battery pack are arranged such that the solar panel charges the battery pack; an inverter electrically coupled with the solar panel and the battery pack, the invertor configured to convert DC power to AC power; an AC power port electrically coupled with the inverter, wherein the AC power port is positioned to provide AC power to one or more electrically powered devices on the exterior of the transportable manufactured housing structure, within the interior of the transportable manufactured housing structure, or combinations thereof; and wherein the inverter is configured to selectively and alternatively provide power to the AC power port from the solar panel and the battery pack.

Embodiment 2. The transportable manufactured housing structure of embodiment 1, wherein the transportable manufactured housing structure is a shipping container, a mobile home, a park model, or a storage unit.

Embodiment 3. The transportable manufactured housing structure of embodiment 1, wherein the transportable manufactured housing structure includes wheels or a skid.

Embodiment 4. The transportable manufactured housing structure of any of embodiments 1 to 3, wherein the solar panel is positioned on the roof of the transportable manufactured housing structure.

Embodiment 5. The transportable manufactured housing structure of any of embodiments 1 to 4, wherein an angle of the solar panel relative to the Sun is adjustable.

Embodiment 6. The transportable manufactured housing structure of any of embodiments 1 to 5, further comprising a mounting device, the mounting device mechanically coupling the solar panel to the transportable manufactured housing structure.

Embodiment 7. The transportable manufactured housing structure of embodiment 6, wherein the mounting device is adjustable to change the declination of the solar panel relative to the Sun.

Embodiment 8. The transportable manufactured housing structure of any of embodiments 1 to 7, wherein the roof of the transportable manufactured housing structure is positioned at an angle relative to the floor of the transportable manufactured housing structure.

Embodiment 9. The transportable manufactured housing structure of embodiment 8, wherein the angle of the roof corresponds with a geographical location of the transportable manufactured housing structure.

Embodiment 10. The transportable manufactured housing structure of any of embodiments 1 to 9, further comprising a charge controller, the charge controller configured to selectively charge the battery pack.

Embodiment 11. The transportable manufactured housing structure of any of embodiments 1 to 10, further comprising a housing, wherein the battery pack and the inverter are contained within the housing.

Embodiment 12. The transportable manufactured housing structure of embodiment 11, wherein the housing is mechanically coupled to the walls, roof, floor, or combinations thereof.

Embodiment 13. The transportable manufactured housing structure of embodiment 11 or 12, wherein the housing is mechanically coupled to the exterior of the transportable manufactured housing structure.

Embodiment 14. The transportable manufactured housing structure of any of embodiments 1 to 13, wherein the one or more electrically powered devices include an air conditioning unit, lights, appliances, a water heater, or combinations thereof.

Embodiment 15. The transportable manufactured housing structure of any of embodiments 1 to 14, wherein the transportable manufactured housing structure is a skid-mounted mobile home that is transportable to remote locations and disaster zones.

Embodiment 16. A process for providing electrically powered living environments in remote locations or disaster zones, the process comprising providing a transportable manufactured housing structure in accordance with any of embodiments 1 to 15.

Embodiment 17. The process of embodiment 16, wherein the location or disaster zone is a geographic location lacking a power grid.

Embodiment 18. The process of embodiment 16, wherein the location or disaster zone is a geographic location having a power grid that is out of service.

Embodiment 19. The process of embodiment 18, wherein the location or disaster zone is a geographic having recently been impacted by an event, wherein the event caused the service of the power grid to be interrupted.

Embodiment 20. The process of embodiment 19, wherein the event is a hurricane, an earthquake, a tornado, a tsunami, or another storm.

Embodiment 21. A process for providing electrically powered living environments in remote locations or disaster zones, the process comprising: integrating a power generation system with a transportable manufactured housing structure; wherein the transportable manufactured housing structure includes a floor structure, multiple walls coupled with the floor structure, and a roof coupled with the multiple walls, wherein the floor structure, walls and roof define an interior of the transportable manufactured housing structure, the interior forming an enclosed living space; wherein the power generation system includes a solar panel positioned on an exterior of the transportable manufactured housing structure; a battery pack electrically coupled with the solar panel, wherein the solar panel and the battery pack are arranged such that the solar panel charges the battery pack; an inverter electrically coupled with the solar panel and the battery pack, the invertor configured to convert DC power to AC power; and an AC power port electrically coupled with the inverter, wherein the AC power port is positioned to provide AC power to one or more electrically powered devices on the exterior of the transportable manufactured housing structure, within the interior of the transportable manufactured housing structure, or combinations thereof; wherein the inverter is configured to selectively and alternatively provide power to the AC power port from the solar panel and the battery pack.

Embodiment 22. The method of embodiment 21, wherein the transportable manufactured housing structure is a shipping container, a mobile home, a park model, or a storage unit.

Embodiment 23. The method of embodiment 21, wherein the transportable manufactured housing structure includes wheels or a skid.

Embodiment 24. The method of any of embodiments 21 to 23, further comprising positioning the solar panel on the roof of the transportable manufactured housing structure.

Embodiment 25. The method of any of embodiments 21 to 24, further comprising adjusting an angle of the solar panel relative to the Sun.

Embodiment 26. The method of any of embodiments 21 to 25, further comprising mounting the solar panel on the transportable manufactured housing structure using a mounting device, the mounting device mechanically coupling the solar panel to the transportable manufactured housing structure.

Embodiment 27. The method of embodiment 26, further comprising adjusting the mounting device to change the declination of the solar panel relative to the Sun.

Embodiment 28. The method of any of embodiments 21 to 27, further comprising positioning the roof of the transportable manufactured housing structure at an angle relative to the floor of the transportable manufactured housing structure.

Embodiment 29. The method of embodiment 28, further comprising corresponding the angle of the roof corresponds with a geographical location of the transportable manufactured housing structure.

Embodiment 30. The method of any of embodiments 21 to 29, further comprising selectively controlling the charging of the battery using a charge controller.

Embodiment 31. The method of any of embodiments 21 to 30, further containing the battery pack and the inverter within a housing.

Embodiment 32. The method of embodiment 31, further comprising mechanically coupling the housing to the walls, roof, floor, or combinations thereof.

Embodiment 33. The method of embodiment 31 or 32, wherein the housing is mechanically coupled to the exterior of the transportable manufactured housing structure.

Embodiment 34. The method of any of embodiments 21 to 33, further comprising powering one or more electrically powered devices including an air conditioning unit, lights, appliances, a water heater, or combinations thereof.

Embodiment 35. The method of any of embodiments 21 to 34, wherein the transportable manufactured housing structure is a skid-mounted mobile home that is transportable to remote locations and disaster zones.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A gridless mobile habitat, the gridless mobile habitat comprising:
an exterior comprising a roof, a floor, and one or more walls, wherein the roof extends within a single plane that is at an angle relative to a plane that the floor extends within;
an interior spaced defined by the exterior;
one or more electrically powerable devices positioned on the exterior, positioned in the interior space, or combinations thereof; and
a power system comprising a battery pack, an inverter, and one or more solar panels positioned on the roof, wherein the one or more solar panels extend within a single plane that is at an angle relative to the plane that the floor extends within; and
wherein the inverter is electrically coupled with the battery pack, the one or more solar panels, and the one or more electrically powered devices, the inverter positioned to distribute electrical power from the battery pack, the one or more solar panels, or combinations thereof to the one or more electrically powered devices;
wherein the roof and the one or more solar panels are positioned at angle relative to the floor that is greater than 0 degrees and less than 90 degrees.

2. The gridless mobile habitat of claim 1, wherein the angle of the one or more solar panels, relative to the floor, is adjustable.

3. The gridless mobile habitat of claim 1, wherein the angle of the one or more solar panels relative to the floor is selected to correspond with a geographic location of the gridless mobile habitat.

4. The gridless mobile habitat of claim 1, wherein the one or more solar panels are coupled with the roof via a mounting device.

5. The gridless mobile habitat of claim 4, wherein the mounting devices is adjustable to provide the one or more solar panels with an adjustable angle, relative to the floor.

6. The gridless mobile habitat of claim 4, wherein the mounting device includes a pivotable bracket, channeling, a hydraulically actuable piston, an electrically actuable piston, or a crank.

7. The gridless mobile habitat of claim 1, wherein the roof is coupled with a first wall and a second wall of the exterior, wherein the first wall has a first height and the second wall has a second height that is less than the first height, such that coupling of the roof with the first and second walls at least partially defines the angle of the roof and the one or more solar panels, relative to the floor.

8. The gridless mobile habitat of claim 1, further comprising an AC power port electrically coupled between the inverter and the one or more electrically powerable devices.

9. The gridless mobile habitat of claim 1, wherein the gridless mobile habitat comprises a manufactured home, a shipping container, a storage facility, a mobile home, or a park model.

10. The gridless mobile habitat of claim 1, wherein the exterior of the gridless mobile habitat is mounted on a skid, the skid including wheels.

11. The gridless mobile habitat of claim 1, further comprising a housing mounted on the exterior, wherein at least a portion of the power system is positioned within the housing.

12. The gridless mobile habitat of claim 1, wherein power system further comprises a charge controller electrically coupled with the battery pack and with the one or more solar panels, the charge controller configured to selectively control charging of the battery pack with power from the one or more solar panels.

13. The gridless mobile habitat of claim 1, wherein the interior space includes an interior ceiling that extends in a plane that is at an angle relative to the floor, and wherein the angle is greater than 0 and less than 90 degrees.

14. The gridless mobile habitat of claim 1, further comprising a water system configured to provide potable water to the gridless mobile habitat, wherein the water system is electrically coupled with and powered by the power system, wherein the water system comprises a water tank containing potable water.

15. The gridless mobile habitat of claim 14, wherein the water system comprises a pump fluidly coupled with the water tank and electrically coupled with the power system.

16. The gridless mobile habitat of claim 15, wherein the pump is fluidly coupled with a sink, shower, refrigerator, dishwasher, water heater, washing machine, water hose, dishwasher, or combinations thereof of the gridless mobile habitat.

17. The gridless mobile habitat of claim 15, wherein the water system comprises a water heater for heating the potable water, the water heater electrically coupled with the power system.

18. The gridless mobile habitat of claim 1, further comprising an electrically powered incinerating toilet positioned within the interior space, wherein the electrically powered incinerating toilet is electrically coupled with the power system.

19. A gridless mobile habitat, the gridless mobile habitat comprising:
an exterior comprising a roof, a floor, and one or more walls, wherein the roof extends within a single plane that is at an angle of from 5 to 60 degrees relative to a plane that the floor extends within;
an interior spaced defined by the exterior;
one or more electrically powerable devices positioned on the exterior, positioned in the interior space, or combinations thereof; and
a power system comprising a battery pack, an inverter, and one or more solar panels positioned on the roof, wherein the one or more solar panels are coupled with the roof via a mounting device that is adjustable to provide the one or more solar panels with an adjustable angle, relative to the floor, and wherein the one or more solar panels extend within a single plane that is at an angle of from 5 to 60 degrees relative to the plane that the floor extends within;
wherein the inverter is electrically coupled with the battery pack, the one or more solar panels, and the one or more electrically powered devices, the inverter positioned to distribute electrical power from the battery pack, the one or more solar panels, or combinations thereof to the one or more electrically powered devices;
a water system configured to provide potable water to the gridless mobile habitat, the water system comprising a water tank containing potable water, a pump fluidly coupled with the water tank and electrically coupled with the power system, and a water heater for heating the potable water, the water heater electrically coupled with the power system, wherein the pump is fluidly coupled with a sink, shower, refrigerator, dishwasher, water heater, washing machine, water hose, dishwasher, or combinations thereof of the gridless mobile habitat; and
an electrically powered incinerating toilet positioned within the interior space, wherein the electrically powered incinerating toilet is electrically coupled with the power system.

20. A method of providing a habitat in a gridless environment, the method comprising:
providing a gridless mobile habitat in a geographic location that lacks a functioning power grid, the gridless mobile habitat comprising:
an exterior comprising a roof, a floor, and one or more walls, wherein the roof extends within a single plane that is at an angle relative to a plane that the floor extends within;
an interior spaced defined by the exterior;
one or more electrically powerable devices positioned on the exterior, positioned in the interior space, or combinations thereof; and
a power system comprising a battery pack, an inverter, and one or more solar panels positioned on the roof, wherein the one or more solar panels extend within a single plane that is at an angle relative to the plane that the floor extends within; and
wherein the inverter is electrically coupled with the battery pack, the one or more solar panels, and the one or more electrically powered devices, the inverter positioned to distribute electrical power from the battery pack, the one or more solar panels, or combinations thereof to the one or more electrically powered devices;
selectively providing power to the one or more electrically powerable devices from the one or more solar panels and the battery pack;
disposing of sewage using an electrically powered incinerating toilet; and
providing potable water from a water system, the water system electrically coupled with the power system.
